(19) United States
(12) Patent Application Publication
(10) Pub. No.: US 2025/0068364 A1
(43) Pub. Date: Feb. 27, 2025

(54) PRINTING SYSTEM, PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventor: GOU SASAKI, Kanagawa (JP)

(21) Appl. No.: 18/798,588

(22) Filed: Aug. 8, 2024

(30) Foreign Application Priority Data
Aug. 25, 2023 (JP) 2023-137005

(51) Int. Cl. G06F 3/12; B41J 29/00

(52) U.S. Cl. CPC G06F 3/121; B41J 29/00; G06F 3/1238; G06F 3/1239

(57) ABSTRACT

A printing apparatus which serves as a target of a service in which a user can use the printing apparatus at a flat rate, the printing apparatus includes one or more processors, and at least one memory having stored thereon instructions, which when executed by the one or more processors, cause the printing apparatus to: restrict the printing performed by the printing apparatus in a state where the printing apparatus cannot communicate with a management server that manages the service and a use amount of a consumable product resulting from printing performed by the printing apparatus satisfies a predetermined condition, and output a code for transmitting information regarding the printing apparatus to the management server via a user terminal.

### BACKGROUND

### Field

The present disclosure relates to a printing apparatus that performs printing by consuming a consumable product, and a printing system where a management server manages the printing apparatus.

### Description of the Related Art

Conventionally, for a printing apparatus such as an inkjet recording apparatus or a copying machine, there has been a subscription service where a user can receive a service including the use of various consumable products and ordering of various consumable products by periodically paying a fixed fee to a management company that manages the printing apparatus. In such a subscription service, the use states of a printing apparatus and a consumable product for the printing apparatus are transmitted from the printing apparatus to a management server that manages the printing apparatus via a network and managed by the management server. Thus, it is desirable to use the subscription service for the printing apparatus in the state where the printing apparatus can communicate with the management server.

Accordingly, the publication of Japanese Patent Application Laid-Open No. 2022-32194 discusses a technique for setting the upper limit of the number of printed images to be printed in the state where a printing apparatus cannot communicate with a management server, and restricting printing in a case where the printing apparatus cannot communicate with the management server and the number of printed images exceeds the upper limit.

In the printing apparatus discussed in the publication of Japanese Patent Application Laid-Open No. 2022-32194, however, a mechanism for transmitting the use state of the printing apparatus to the management server via another apparatus in the state where the printing apparatus cannot communicate with the management server is not considered.

### SUMMARY

The present disclosure is directed to providing a mechanism for, in the state where a printing apparatus cannot communicate with a management server, transmitting the use state of the printing apparatus to the management server via another apparatus.

According to an aspect of the present disclosure, a printing apparatus which serves as a target of a service in which a user can use the printing apparatus at a flat rate, the printing apparatus includes one or more processors, and at least one memory having stored thereon instructions, which when executed by the one or more processors, cause the printing apparatus to: restrict the printing performed by the printing apparatus in a state where the printing apparatus cannot communicate with a management server that manages the service and a use amount of a consumable product resulting from printing performed by the printing apparatus satisfies a predetermined condition, and output a code for transmitting information regarding the printing apparatus to the management server via a user terminal.

Further features of the present disclosure will become apparent from the following description of exemplary embodiments with reference to the attached drawings.

### BRIEF DESCRIPTION OF THE DRAWINGS

FIG. 1 is a block configuration diagram of a recording system according to the present exemplary embodiment.

FIGS. 2A and 2B are block configuration diagrams of a recording apparatus and a host terminal.

FIG. 3 is a sequence diagram of a contract process according to the present exemplary embodiment.

FIG. 4 is a flowchart of a recording process according to the present exemplary embodiment.

FIG. 5 is a flowchart of an online recording process, which is a subroutine of the recording process in FIG. 4.

FIG. 6 is a flowchart of an offline recording process, which is a subroutine of the recording process in FIG. 4.

FIG. 7 is a sequence diagram of a process for continuing printing in an offline state according to the present exemplary embodiment.

FIGS. 8A, 8B, and 8C are diagrams illustrating examples of display on a display unit of the recording apparatus according to the present exemplary embodiment.

FIGS. 9A and 9B are diagrams illustrating examples of display on a display unit of the host terminal according to the present exemplary embodiment.

### DESCRIPTION OF THE EMBODIMENTS

With reference to the attached drawings, an example of a recording system according to the present exemplary embodiment will be described in detail below. The following exemplary embodiments do not limit the present disclosure, and not all the combinations of the features described in the exemplary embodiments are essential for a method for solving the issues in the present disclosure. The relative positions and the shapes of the components described in the exemplary embodiments are merely illustrative, and are not intended to limit the scope of the present disclosure to them only, unless otherwise noted.

In the following exemplary embodiment, printing on a print medium such as a sheet will be referred to as “recording on a recording medium”. A printing apparatus that performs such printing will be referred to as a “recording apparatus”. A user terminal that communicates with a server will be referred to as a “host terminal”. For example, the host terminal is a mobile terminal or a smartphone.

In the state where a recording apparatus according to the present exemplary embodiment can communicate with a server (also referred to as an “online state”), the recording apparatus transmits recording information including the number of printed images (also referred to as “the number of recorded images”) printed by the recording apparatus to the server. On the other hand, in the state where the recording apparatus cannot communicate with the server (also referred to as an “offline state”), the recording apparatus can perform recording, but the upper limit number of images to be recorded in the offline state is set. Specifically, in the case of a subscription service where the upper limit of the number of recorded images to be recorded is set to 50 per month, the recording apparatus can record up to 25 images in the offline state. At the time when the number of recorded images reaches 25, the recording in the offline state is restricted. That is, the number of images smaller than the monthly upper limit number of images in the online state is set.

In the following exemplary embodiment, the number of recorded images is counted by the recording apparatus. The number of recorded images may be the number of print sheets used for printing, or may be the number of pages of document included in printed data. As print settings, there are two-sided printing for printing different pages on both sides of a single sheet and “N-in-1 printing” for printing data of a plurality of pages on a single sheet. If the number of recorded images is the number of sheets and the above print settings are made, the number of recorded images smaller than the number of pages in data as a printing target is counted by the recording apparatus. Alternatively, the number of recorded images may be the number of printed sides. A “side” in the number of printed sides refers to a single surface of an output sheet. For example, in a case where the two-sided printing is performed, printing can be performed on two sides, namely the front and back sides, of a single output sheet. That is, in a case where printing is performed on the front and back sides by performing the two-sided printing, two is counted as the number of printed sides. Even in a case where the two-sided printing is set, if printing is performed on only the front side, one is counted as the number of printed sides. Even in a case where the “N-in-1 printing” is executed, the number of sides of output sheets used for printing is counted as the number of printed sides.

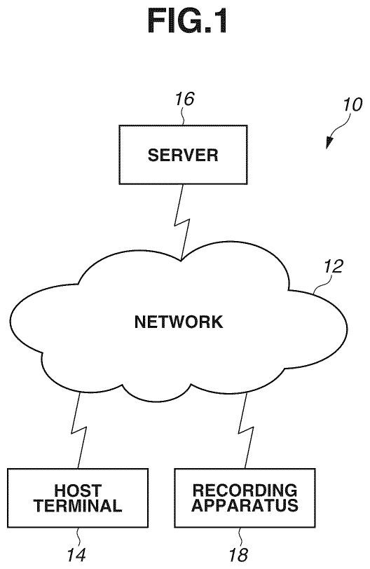

First, with reference to FIGS. 1 to 9B, a recording system according to a first exemplary embodiment will be described.

FIG. 1 is a block configuration diagram of the recording system according to the first exemplary embodiment.

### <Configuration of Recording System>

A recording system 10 includes a host terminal 14, a server 16, and a recording apparatus 18 that are connected to each other via a network 12 so that these apparatuses can communicate with each other. The host terminal 14 outputs a recording instruction and various pieces of information to the recording apparatus 18. The present disclosure is not limited to a form in which the host terminal 14 is connected to the recording apparatus 18 via the network 12, and a configuration may be employed in which the host terminal 14 is directly connected to the recording apparatus 18 not via the network 12. The server 16 may include a single server apparatus, or a server system where a plurality of server apparatuses cooperates with each other may operate as the server 16.

For example, the host terminal 14 is used by a user to make a contract for the subscription service for periodically using a consumable product for the recording apparatus 18 at a fixed fee with a management company that manages the subscription service via the server 16. Specifically, the host terminal 14 holds information regarding the recording apparatus 18. When a contract for the subscription service is made, the host terminal 14 outputs user information input to the host terminal 14 and information regarding the recording apparatus 18 to the server 16. For example, the information regarding the recording apparatus 18 is information identifying the recording apparatus 18. For example, the server 16 outputs information regarding contracts of various services provided by the management company that manages the subscription service to the host terminal 14. The host terminal 14 may hold the information regarding the recording apparatus 18 as described above, or if the user instructs the host terminal 14 to use the subscription service, the host terminal 14 may acquire the information from the recording apparatus 18. The host terminal 14 is connected to the recording apparatus 18 via a wired connection using a Universal Serial Bus (USB) or a wired local area network (LAN) or a wireless connection using a wireless LAN. The host terminal 14 acquires the information from the recording apparatus 18 through these connections.

The server 16 is managed by the management company that provides the subscription service. The server 16 is a management server that manages the user who uses the subscription service and the recording apparatus 18, and also manages the use state of the consumable product for the recording apparatus 18. For example, the use state of the consumable product refers to the number of recorded images, recording information (a log) including the number of recorded images, and the remaining amount of ink. The server 16 also performs a contract process regarding the subscription service by exchanging various pieces of information with the host terminal 14. Further, the server 16 outputs to the recording apparatus 18 a value to be set as the number of recorded images that can be recorded in a case where the recording apparatus 18 enters an offline state where the recording apparatus 18 cannot communicate with the server 16 (the upper limit value of the number of recorded images in the offline state). The upper limit value of the number of recorded images in the offline state is a value associated with the content of the plan of the subscription service. For example, in a case where there exists a plurality of subscription services having different service contents, the upper limit value of the number of recorded images in the offline state is a value that differs according to the type of the subscription service. Further, the upper limit value of the number of recorded images in the offline state may be set to a fixed value according to the type of the subscription service, or may vary according to the remaining amount of ink in the recording apparatus 18 at the timing when the server 16 and the recording apparatus 18 communicate with each other.

### <Configuration of Recording Apparatus>

Based on a job output from the host terminal 14 or a personal computer (PC) (not illustrated), the recording apparatus 18 executes recording based on image data. In the present exemplary embodiment, the recording apparatus 18 is an inkjet recording apparatus that performs recording by discharging ink to a recording medium. The recording apparatus 18 is not limited to an inkjet recording apparatus, and may be a recording apparatus using any recording method so long as the recording apparatus performs recording by consuming a consumable product. For example, the recording apparatus 18 may be a recording apparatus that performs recording using toner as a consumable product.

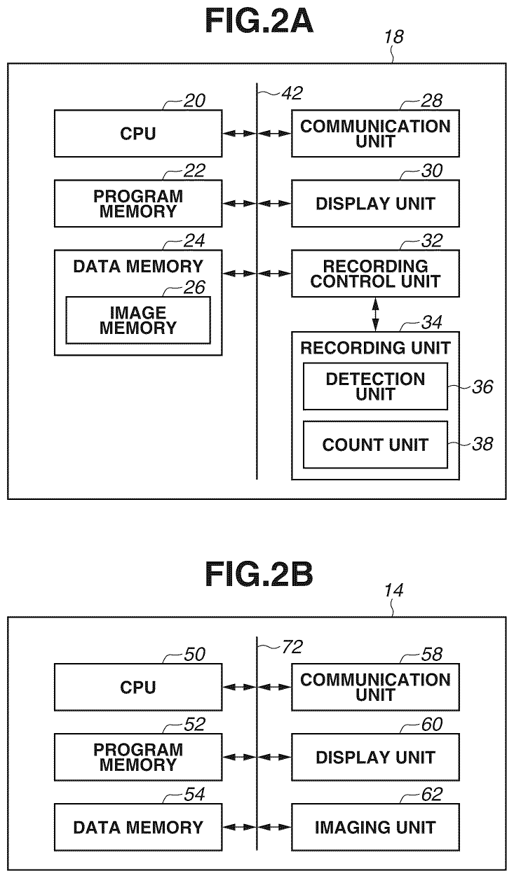

FIG. 2A is a block configuration diagram illustrating an example of the hardware configuration of the recording apparatus 18. The recording apparatus 18 includes a central processing unit (CPU) 20, a program memory 22, a data memory 24, a communication unit 28, a display unit 30, a recording control unit 32, and a recording unit 34. These components are connected to each other via a system bus 42 managed by the CPU 20.

The CPU 20 is a system control unit and controls the entirety of the recording apparatus 18. The program memory 22 stores a control program executed by the CPU 20 and an embedded operating system (OS) program. The data memory 24 includes an image memory 26 that holds image data. The data memory 24 also stores various pieces of information such as a program control variable. In the data memory 24, various work buffer areas used for the processing of the recording control unit 32 are provided.

The communication unit 28 connects to an external apparatus via the USB or the network 12. The communication unit 28 controls the transmission and reception of data to and from an apparatus externally connected to the recording apparatus 18 via the network 12. That is, the communication unit 28 connects to the USB or the network 12 and communicates with an external apparatus. For example, the display unit 30 is composed of a liquid crystal display (LCD) and can display a character, a figure, and an indicator. Examples of information displayed on the display unit 30 include setting information and status information regarding the recording apparatus 18. The display unit 30 also has the function of enabling the user to perform an input operation using a touch panel method and is controlled by the CPU 20. A form can also be employed in which the user performs various operations using a switch and a hardware key. The recording control unit 32 acquires data for recording from the image memory 26 that accumulates image data processed by an image processing unit (not illustrated). Then, the recording control unit 32 controls recording performed by the recording unit 34.

The recording unit 34 performs recording under control of the recording control unit 32. The recording unit 34 includes a detection unit 36 that detects that an attached cartridge (a cartridge that stores ink used for printing) is a cartridge dedicated to the subscription service, and a count unit 38 that counts the number of recorded images. For example, based on information in a chip provided in the attached cartridge, the detection unit 36 can determine whether the attached cartridge is a cartridge dedicated to the subscription service. The recording unit 34 may include components that detect the remaining amount of ink in a cartridge and the consumption amount of ink consumed by recording.

The recording apparatus 18 outputs acquired recording information to the server 16. The recording information refers to a log obtained by putting together a job mode such as a copy mode or a print mode, the number of recorded images, and the recording result and is generated on a job-by-job basis. In a case where the recording apparatus 18 includes the components that detect the remaining amount of ink in a cartridge and the consumption amount of ink, the recording information may include the results of detecting the remaining amount of ink in a cartridge and the consumption amount of ink. The recording information is output from the CPU 20 or the recording control unit 32 via the communication unit 28. For example, the recording information is stored in the data memory 24. A log in the offline state is stored in the data memory 24, and if the offline state transitions to an online state, the log is transmitted to the server 16. If the log is transmitted to the server 16, the log is deleted. In the data memory 24, a predetermined capacity capable of storing recording information (a log) is determined in advance, and if stored recording information reaches the predetermined capacity, an error occurs.

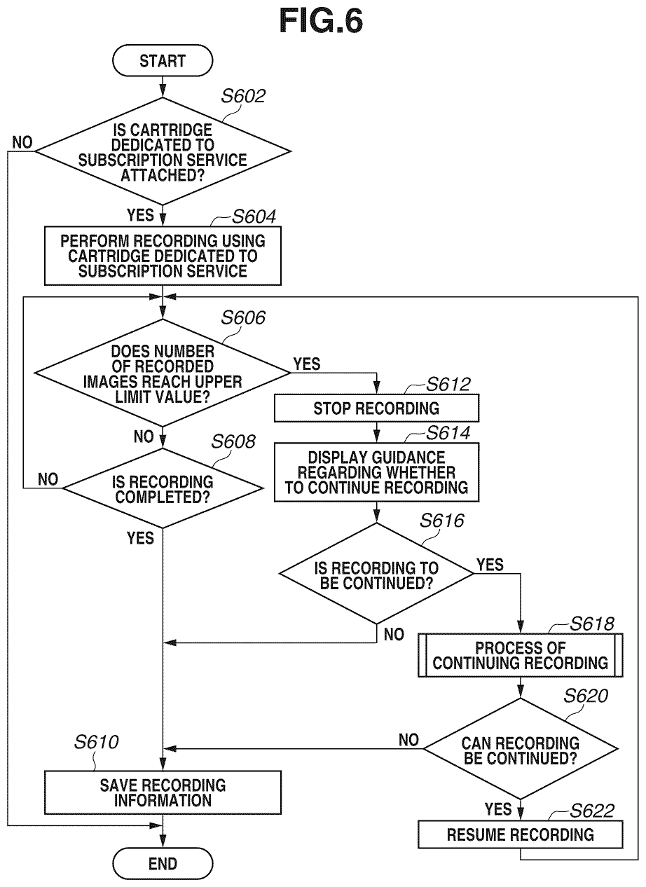

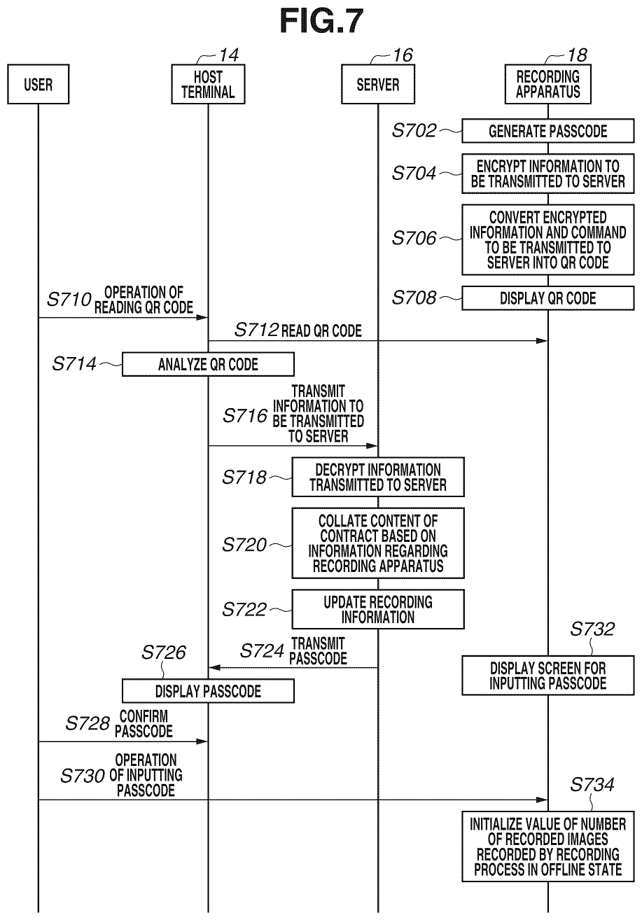

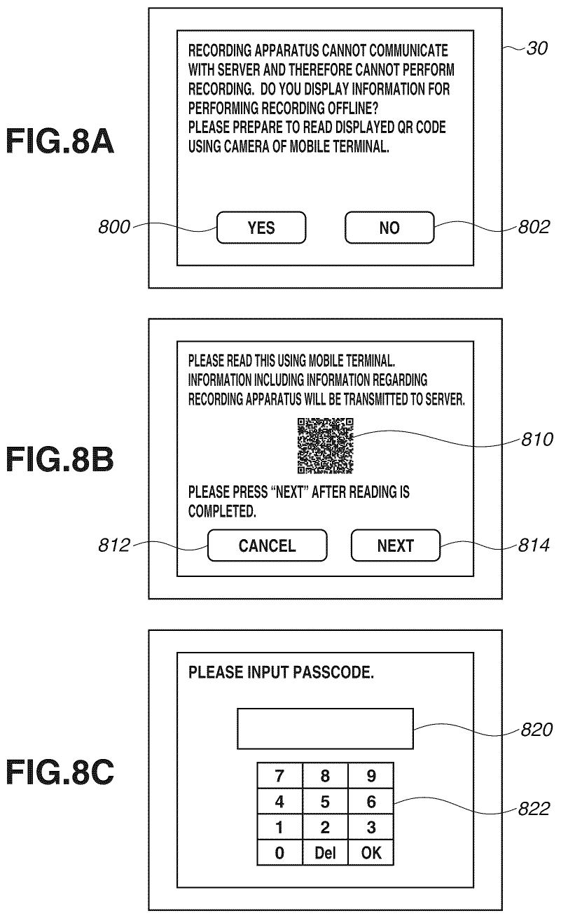

With reference to FIGS. 8A to 8C, a description will be given of an example of an error displayed on the display unit 30 of the recording apparatus 18 in a case where a predetermined condition is satisfied in the situation where the recording apparatus 18 cannot communicate with the server 16. FIG. 8A illustrates an example of a screen displayed when the number of recorded images recorded in the offline state by the recording apparatus 18 reaches the upper limit value. FIG. 8B illustrates an example of a screen displaying a Quick Response (QR) code (registered trademark) in a case where the number of recorded images recorded in the offline state by the recording apparatus 18 reaches the upper limit value and recording based on the subscription service continues to be used, i.e., in a case where a button 800 is pressed. FIG. 8C illustrates an example of a screen displayed to input a passcode in a case where the number of recorded images recorded in the offline state by the recording apparatus 18 reaches the upper limit value and recording based on the subscription service continues to be used. This screen is displayed in a case where a button 814 is pressed on the screen in FIG. 8B. A detailed description will be given with reference to a flowchart in FIG. 6 and a sequence diagram in FIG. 7.

### <Configuration of Host Apparatus>

FIG. 2B is a block configuration diagram of the host terminal 14. The host terminal 14 includes a CPU 50, a program memory 52, a data memory 54, a communication unit 58, a display unit 60, and an imaging unit 62. These components are connected to each other via a system bus 72 managed by the CPU 50.

The CPU 50 is a system control unit and controls the entirety of the host terminal 14. The program memory 52 stores a control program executed by the CPU 50 and an embedded OS program. The data memory 54 stores various pieces of information such as a program control variable. In the data memory 54, various work buffer areas used for the processing of the imaging unit 62 are provided. The communication unit 58 controls the transmission and reception of data to and from an apparatus externally connected to the host terminal 14 via the network 12 or a telephone line (not illustrated). Additionally, the host terminal 14 includes the display unit 60 and the imaging unit 62. For example, the display unit 60 is an LCD. The display unit 60 has the function of enabling the user to perform an input operation using a touch panel method and is controlled by the CPU 50. The display unit 60 can enable the user to perform various input operations and display the operating state of the host terminal 14. The imaging unit 62 has the function of electronically recording an image input via a lens and encoding the image. An image captured by the imaging unit 62 is temporarily saved in the data memory 54.

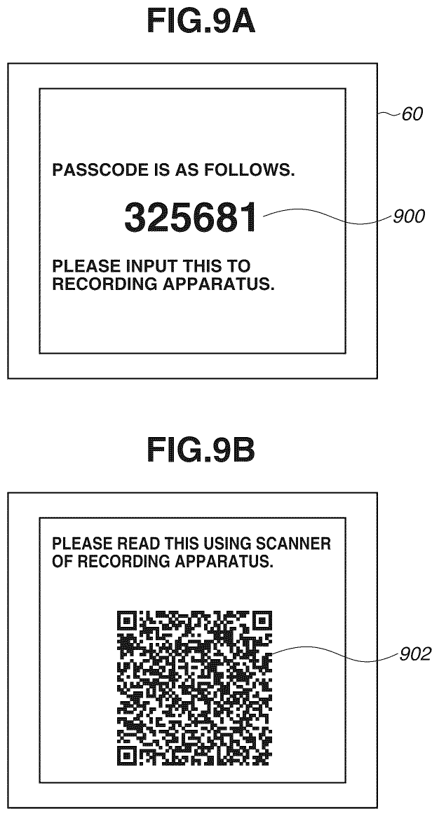

FIGS. 9A and 9B are diagrams illustrating examples of screens displayed on the display unit 60 of the host terminal 14. FIG. 9A illustrates an example of a screen displaying a passcode output from the server 16 to the host terminal 14 and used in the present exemplary embodiment. A detailed description will be given with reference to FIG. 7. FIG. 9B illustrates an example of a screen displaying a QR code output from the server 16 to the host terminal 14. A detailed description will be given in another exemplary embodiment.

### <Contract Process>

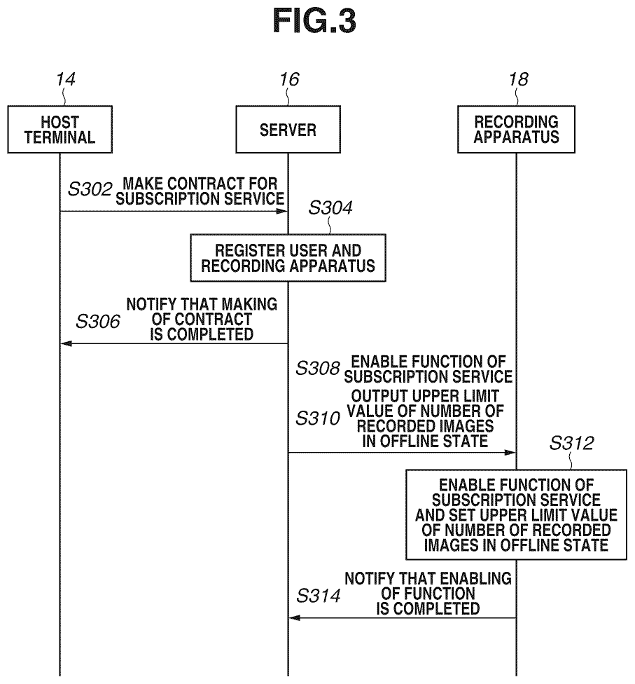

In the above configuration, in the recording system 10, the user makes a contract to use the subscription service with the management company, using the host terminal 14. FIG. 3 is a sequence diagram of a contract process for making a contract for the subscription service. Processes in the sequence diagram illustrated in FIG. 3 are performed by the CPU of each apparatus executing a program stored in a storage unit.

First, in step S302, the host terminal 14 transmits information input by the user for making a contract for the subscription service to the server 16. Specifically, in step S302, the host terminal 14 and the server 16 repeatedly exchange various pieces of information with each other. The exchanged various pieces of information include user information, information regarding the recording apparatus 18, and plan information regarding the subscription service as contract information for making a contract for the subscription service. The information regarding the recording apparatus 18 includes identification information regarding the recording apparatus 18.

Next, in step S304, based on the contract information, the server 16 registers the user and the recording apparatus 18. That is, the server 16 registers the user information and the information regarding the recording apparatus 18 as a target that can receive the subscription service. Then, in step S306, the server 16 notifies the host terminal 14 that the making of a contract to use the subscription service is completed. In step S308, the server 16 outputs a command to enable the function of the subscription service to the recording apparatus 18. In step S310, the server 16 outputs the number of recorded images that can be recorded in the offline state. That is, in step S310, the server 16 outputs to the recording apparatus 18 the upper limit value of the number of recorded images in the offline state set as the number of recorded images that can be recorded by the recording apparatus 18 in the offline state. In step S308, for example, contract information indicating that the user is under contract for the subscription service is output to the recording apparatus 18. Then, the contract information is held in the recording apparatus 18.

Then, in step S312, based on the input information, the recording apparatus 18 enables the function of the subscription service and also sets the upper limit value of the number of recorded images in the offline state. In step S314, the recording apparatus 18 notifies the server 16 that the enabling of the function of the subscription service is completed. That is, in step S312, for example, the recording apparatus 18 changes the use mode of the recording apparatus 18 from a normal mode for performing recording using a commercial cartridge to a service mode for performing recording using a cartridge dedicated to the subscription service. The recording apparatus 18 also sets the upper limit value of the number of recorded images that can be recorded that is input from the server 16 when the recording apparatus 18 is in the offline state. For example, the upper limit value is stored in the data memory 24. Consequently, if the number of recorded images in the offline state reaches the set upper limit value, the recording apparatus 18 is restricted from performing recording based on the subscription service. In the following description, the upper limit value of the number of recorded images in the offline state that is set for the recording apparatus 18 is referred to simply as “the upper limit value”, where appropriate. Alternatively, in step S310, the server 16 may output to the recording apparatus 18 a threshold for the remaining amount of ink to automatically order an ink cartridge dedicated to the subscription service. Then, in step S312, the recording apparatus 18 may set the threshold. If the remaining amount of ink falls below the threshold, the recording apparatus 18 displays a warning indicating that the remaining amount of ink has fallen below the threshold. If information regarding the remaining amount of ink is transmitted to the server 16 and the recording apparatus 18 is notified that a process for ordering the ink cartridge is performed by the server 16, the warning is lifted. Alternatively, a configuration may be employed in which, after the recording apparatus 18 transmits the information regarding ink to the server 16, the server 16 does not transmit to the recording apparatus 18 a notification that a process for ordering the ink cartridge has been performed. In this configuration, after a certain time elapses since the warning indicating that the remaining amount of ink had fallen below the threshold has been displayed, the recording apparatus 18 automatically lifts the warning. Alternatively, the recording apparatus 18 displays an OK button, and if the recording apparatus 18 detects that the pressing of the OK button is received from the user, the recording apparatus 18 automatically lifts the warning. Also in such a configuration, it is possible to apply the present disclosure to notify the server 16 that the remaining amount of ink had fallen below the threshold in the offline state.

### <Recording Process>

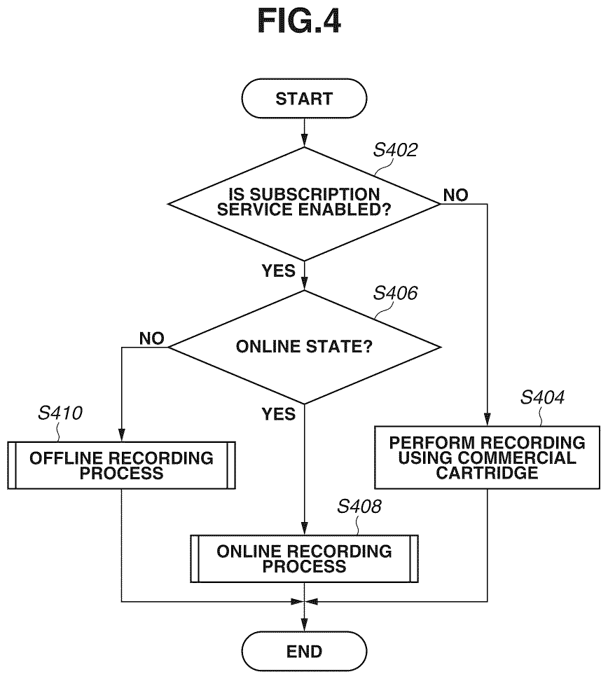

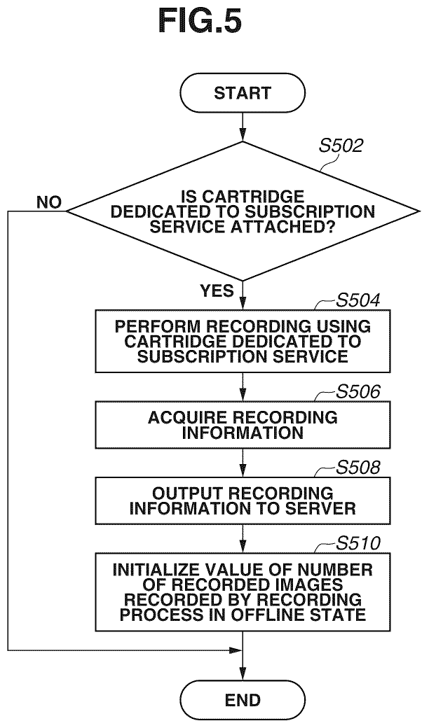

In the recording system 10, if the host terminal 14 instructs the recording apparatus 18 to start recording based on a job, a recording process is started. FIG. 4 is a flowchart illustrating a detailed processing routine of the recording process executed by the recording apparatus 18. FIG. 5 is a flowchart illustrating the detailed processing content of an online recording process, which is a subroutine of the recording process in FIG. 4. FIG. 6 is a flowchart illustrating the detailed processing content of an offline recording process, which is a subroutine of the recording process in FIG. 4. The series of processes illustrated in the flowcharts in FIGS. 4, 5, and 6 is performed by the CPU 20 loading a program code stored in the program memory 22 into the data memory 24 and executing the program code. Alternatively, some or all of the functions of steps in FIGS. 4, 5, and 6 may be executed by hardware such as an application-specific integrated circuit (ASIC) or an electric circuit. FIG. 7 is a sequence diagram illustrating the content of a process for continuing recording in the offline state.

If the recording process is started, first, in step S402, the CPU 20 determines whether the function of the subscription service is enabled. That is, in step S402, for example, the CPU 20 determines whether the use mode is set to the service mode. Then, if the use mode is the service mode, it is determined that the function of the subscription service is enabled. If the use mode is the normal mode, it is determined that the function of the subscription service is not enabled. Alternatively, it is determined whether the contract information indicating that the user is under contract for the subscription service is held in the recording apparatus 18. If the contract information is held, it is determined that the function of the subscription service is enabled. If the contract information is not held, it is determined that the function of the subscription service is not enabled.

If it is determined in step S402 that the function of the subscription service is not enabled (NO in step S402), then in step S404, the CPU 20 performs recording using a commercial cartridge, and the recording process ends. In step S404, if the detection unit 36 detects that a commercial cartridge is attached, i.e., an attached cartridge is not a cartridge dedicated to the subscription service, the CPU 20 acquires data for recording from the image memory 26 and performs recording based on the acquired data. If the detection unit 36 detects that the attached cartridge is a cartridge dedicated to the subscription service, the detection unit 36 gives a notification that an appropriate cartridge is not attached. Then, the recording process ends.

If it is determined in step S402 that the function of the subscription service is enabled (YES in step S402), then in step S406, the CPU 20 determines whether the recording apparatus 18 is in the online state where the recording apparatus 18 can communicate with the server 16. That is, in step S406, for example, the recording apparatus 18 outputs a signal for confirming whether the recording apparatus 18 is in the online state via the communication unit 28. Then, if a signal indicating that the recording apparatus 18 is in the online state is input from the server 16, the CPU 20 determines that the recording apparatus 18 is in the online state. If this signal is not input for a predetermined time, the CPU 20 determines that the recording apparatus 18 is not in the online state, i.e., the recording apparatus 18 is in the offline state. If it is determined in step S406 that the recording apparatus 18 is in the online state (YES in step S406), then in step S408, the recording apparatus 18 executes an online recording process. If it is determined in step S406 that the recording apparatus 18 is not in the online state (NO in step S406), then in step S410, the recording apparatus 18 executes an offline recording process.

Next, with reference to FIG. 5, the online recording process, which is a subroutine of the recording process, will be described. If the online recording process in step S408 is started, first, in step S502, the CPU 20 determines whether a cartridge dedicated to the subscription service is attached. That is, in step S502, based on the detection result of the detection unit 36, the CPU 20 determines whether a cartridge dedicated to the subscription service is attached. In a case where a plurality of cartridges is attached to the recording apparatus 18, and for example, if it is detected that all of the plurality of cartridges is cartridges dedicated to the subscription service, then in step S502, it is determined that a cartridge dedicated to the subscription service is attached. If it is detected that at least one of the plurality of cartridges is not a cartridge dedicated to the subscription service, then in step S502, it is determined that a cartridge dedicated to the subscription service is not attached. Alternatively, in step S502, if it is detected that at least one of the plurality of cartridges is a cartridge dedicated to the subscription service, it may be determined that a cartridge dedicated to the subscription service is attached. In this case, if it is detected that all of the plurality of cartridges is not cartridges dedicated to the subscription service, it is determined in step S502 that a cartridge dedicated to the subscription service is not attached.

If it is determined in step S502 that a cartridge dedicated to the subscription service is not attached (NO in step S502), since a cartridge dedicated to the subscription service is not attached, the CPU 20 gives a notification that recording based on the subscription service cannot be executed. Then, the online recording process ends. Consequently, the recording process ends. If it is determined in step S502 that a cartridge dedicated to the subscription service is attached (YES in step S502), then in step S504, the CPU 20 performs recording based on the job using the cartridge. In step S504, at the start of the recording, the count unit 38 starts counting the number of recorded images. During the recording, the count unit 38 continues to count the number of recorded images.

If the recording is completed, next, in step S506, the CPU 20 acquires recording information. In step S508, the CPU 20 outputs the recording information to the server 16. The recording information may include various pieces of information regarding a consumable product consumed by the recording in step S504. For example, the recording information includes information regarding the number of recorded images and information regarding the remaining amount of ink. The number of recorded images in the recording information acquired in step S506 is a value obtained by totaling the number of recorded images recorded in step S504 and the number of recorded images in the offline recording process (described below) stored in the data memory 24, for example. Based on the recording information output from the recording apparatus 18, the server 16 updates the value of the number of recorded images associated with the recording apparatus 18. The number of recorded images in the offline recording process is the number of images recorded in the offline recording process in step S410.

Then, in step S510, the CPU 20 initializes the value of the number of recorded images in the offline recording process stored in the data memory 24, and the online recording process ends. Consequently, the recording process ends. The number of recorded images in the offline recording process may be stored in a storage area other than the data memory 24. In the online recording process, if it is determined in step S502 that a cartridge dedicated to the subscription service is not attached, the recording process ends. The present disclosure, however, is not limited to this. That is, if it is determined that a cartridge dedicated to the subscription service is not attached, recording using a commercial cartridge may be executed. At this time, the CPU 20 may change the use mode of the recording apparatus 18 from the service mode for using the subscription service to the normal mode. Alternatively, the CPU 20 may display on a display screen included in the recording apparatus 18 an inquiry screen for inquiring of the user about whether to change the use mode to the normal mode or attach a cartridge dedicated to the subscription service. In this case, if the user gives an instruction to change modes on the inquiry screen, the CPU 20 changes the use mode to the normal mode. If, on the other hand, the user gives an instruction to attach a cartridge dedicated to the subscription service, the process of step S502 is executed again.

In the online recording process, after the process of step S510. the server 16 may determine whether the recording based on the subscription service can be continued. That is, based on the received recording information, the server 16 determines whether the number of recorded images has reached the limit of the number of recorded images within which the subscription service can be used. If it is determined that the number of recorded images has reached the limit, the server 16 outputs an instruction to stop using the subscription service to the recording apparatus 18. Then, if the recording apparatus 18 receives the instruction to stop using the subscription service, the recording apparatus 18 performs a process of disabling the subscription service, thereby preventing the execution of recording based on the subscription service. At this time, the CPU 20 of the recording apparatus 18 may display on the display screen of the recording apparatus 18 a message indicating that printing can be further performed by paying an additional fee or using a service of a higher plan. Then, the user may access the server 16 using the host terminal 14 and indicate to the server 16 that the user agrees to pay the additional fee or shift to the higher plan. As a result, the server 16 may newly set a greater number of images as the upper limit number of recorded images to be recorded in the online state by the recording apparatus 18. Consequently, the recording apparatus 18 may be able to perform recording in the online state until the number of recorded images reaches the new upper limit number of images.

Next, the offline recording process, which is a subroutine of the recording process, will be described with reference to FIG. 6.

If the offline recording process in step S410 is started, first, in step S602, the CPU 20 determines whether a cartridge dedicated to the subscription service is attached. The specific processing content of step S602 is similar to that of step S502, and therefore will not be described in detail. If it is determined in step S602 that a cartridge dedicated to the subscription service is not attached (NO in step S602), the CPU 20 gives a notification that recording cannot be performed because a cartridge dedicated to the subscription service is not attached. Then, the offline recording process ends. Consequently, the recording process ends. Alternatively, if it is determined that a cartridge dedicated to the subscription service is not attached, similarly to the recording process in the online state, recording using a commercial cartridge may be executed.

If it is determined in step S602 that a cartridge dedicated to the subscription service is attached (YES in step S602), then in step S604, the CPU 20 starts recording based on the job using the cartridge. In step S604, if the recording is started, the count unit 38 starts counting the number of recorded images. Then, in step S606, every time the count unit 38 counts the number of recorded images, the CPU 20 adds the count value of the count unit 38 to the number of recorded images in the offline recording process saved in the data memory 24 and determines whether the addition value has reached the set upper limit value.

In the online recording process, the number of recorded images in the offline recording process is initialized in step S510. Thus, if the recording process immediately before the currently executed offline recording process is the online recording process, the number of recorded images in the offline recording process is “O” in step S606, and therefore, the addition value matches the count value. If, on the other hand, the recording process immediately before the currently executed offline recording process is the offline recording process, the number of recorded images in the offline recording process is “n (n is a natural number)” in step S606, and therefore, the addition value is a value obtained by adding the count value to “n”. The set upper limit value is the value set in step S312.

If it is determined in step S606 that the addition value has not reached the upper limit value (NO in step S606), then in step S608, the CPU 20 determines whether the recording based on the job is completed. If it is determined that the recording is not completed (NO in step S608), the processing returns to step S606. If it is determined in step S608 that the recording is completed (YES in step S608), then in step S610, the CPU 20 saves recording information in the data memory 24, and the offline recording process ends. Consequently, the recording process ends. In step S610, for example, the CPU 20 updates the value of the number of recorded images in the offline recording process saved in the data memory 24 to the addition value.

If it is determined in step S606 that the addition value of the number of recorded images has reached the upper limit value (YES in step S606), then in step S612, the CPU 20 temporarily restricts the recording, i.e., stops the recording. In step S614, at this time, the CPU 20 gives a notification that the recording in the offline state has been restricted, and also displays on the display unit 30 the screen in FIG. 8A as a guidance regarding whether to lift the restriction of the recording using the host terminal 14. In step S616, if the user does not wish to continue the recording, the user presses a button 802 in FIG. 8A. Thus, it is determined that the recording is not to be continued (NO in step S616), and the recording process ends. Then, step S610 is performed, and the offline recording process ends. In step S616, if the user wishes to continue the recording offline, the user presses the button 800 in FIG. 8A. If the CPU 20 detects the pressing of the button 800 (YES in step S616), then in step S618, the CPU 20 performs a process for continuing the recording. The process for continuing the recording in step S618 will be described in detail with reference to FIG. 7. As a result of the process for continuing the recording, if the CPU 20 determines in step S620 that the recording can be continued (YES in step S620), the CPU 20 lifts the restriction of the recording. That is, in step S622, the CPU 20 resumes the recording. Then, the processing returns to step S606. If it is determined in step S620 that the recording cannot be continued (NO in step S620), the CPU 20 ends the recording without lifting the restriction of the recording. Then, step S610 is performed, and the offline recording process ends.

In the state where the recording is restricted in the offline recording process, at a predetermined timing during the online state of the recording apparatus 18, the recording apparatus 18 notifies the server 16 of recording information and also notifies the server 16 that the recording in the offline recording process is restricted. Then, for example, based on the notification and the recording information, the server 16 determines whether the subscription service can continue to be used. Then, the server 16 outputs the result of the determination to the recording apparatus 18. In this case, if the recording in the offline recording process is restricted, the recording apparatus 18 restricts the online recording process and the offline recording process until the recording apparatus 18 receives the determination regarding the continuation of the use of the subscription service from the server 16 or it is determined that the recording based on the subscription service can be continued by performing the process for continuing the recording.

The recording information saved in the data memory 24 is transmitted to the server 16 in the online state of the recording apparatus 18 and at the timing when the currently executed operation is not influenced. Alternatively, the recording information may be transmitted when information is transmitted to the server 16 during the online recording process (e.g., in step S508). After the recording information is transmitted, the number of recorded images in the offline recording process is initialized.

### <Process for Continuing Recording>

If it is determined that the recording apparatus 18 is to continue the recording in the offline state, the process for continuing the recording in the offline state is started. FIG. 7 is a sequence diagram illustrating the detailed processing content of the process for continuing the recording in the offline state that is executed in the recording system 10. The processing of the recording apparatus 18 in the sequence in FIG. 7 is performed by the CPU 20 loading a program code stored in the program memory 22 into the data memory 24 and executing the program code. Alternatively, some or all of the functions of steps performed by the recording apparatus 18 in FIG. 7 may be executed by hardware such as an ASIC or an electric circuit. The processing of the host terminal 14 is performed by the CPU 50 loading a program code stored in the program memory 52 into the data memory 54 and executing the program code.

First, in step S702, the CPU 20 of the recording apparatus 18 generates a passcode. In the present exemplary embodiment, the passcode is represented by a random six-digit number. The present disclosure, however, is not limited to this. The passcode may also be represented by alphabetical letters or a mixture of a number and alphabetical letters. Every time step S702 is performed, the passcode is updated to a new value. Next, in step S704, the CPU 20 encrypts various pieces of information to be transmitted to the server 16. The various pieces of information to be transmitted to the server 16 include information identifying the recording apparatus 18, i.e., identification information regarding the recording apparatus 18, recording information, and the passcode created in step S702. The present disclosure, however, is not limited to this. In a case where an error occurs in the recording apparatus 18 during the offline state, error information may be stored in the data memory 24 and included in the various pieces of information to be transmitted to the server 16. For example, the various pieces of information to be transmitted to the server 16 include at least one of the number of recorded images in the offline state, the remaining amount of ink, and a log. If an error in a case where the number of recorded images in the offline state reaches a predetermined upper limit number of images, or an error in a case where the remaining amount of ink falls below the threshold for automatic ordering, or an error in a case where the log reaches the upper limit of capacity capable of storing recording information occurs, information regarding the error is included in the various pieces of information to be transmitted to the server 16.

Next, in step S706, the CPU 20 converts the encrypted various pieces of information and a command to be transmitted to the server 16 into a QR code that can be read by an external device. The command to be transmitted to the server 16 also includes address information regarding the server 16. Then, in step S708, the CPU 20 displays on the display unit 30 a guidance including a QR code 810 obtained by converting the encrypted various pieces of information illustrated in FIG. 8B. In step S710, according to the guidance in FIG. 8B, the user performs an operation of reading the QR code using the imaging unit 62 of the host terminal 14. In step S712, the host terminal 14 reads the QR code. After reading the QR code, then in step S714, the host terminal 14 analyzes the read QR code. In step S716, based on the transmission command for transmission to the server 16, the host terminal 14 transmits the encrypted various pieces of information to the server 16.

If the server 16 receives the encrypted various pieces of information, then in step S718, the server 16 decrypts the encrypted various pieces of information to acquire the various pieces of information. In step S720, the server 16 acquires the information identifying the recording apparatus 18 from the decrypted information and collates contract information regarding the subscription service managed by the server 16 and associated with the information identifying the recording apparatus 18. If the corresponding contract information is collated, then in step S722, the server 16 acquires the recording information from the decrypted information, and based on information included in the recording information, updates use information regarding a consumable product corresponding to the recording apparatus 18 that is managed by the server 16. Then, similarly to the online recording process, the server 16 may determine whether the recording based on the subscription service can be continued. That is, in step S724, based on the recording information, the server 16 determines whether the number of recorded images has reached the limit of the number of recorded images within which the subscription service can be used. If it is determined that the number of recorded images has not reached the limit, the server 16 acquires the passcode from the decrypted information and transmits the passcode to the host terminal 14. If the host terminal 14 receives the passcode, then in step S726, the host terminal 14 displays the screen in FIG. 9A on the display unit 609. If the reading of the QR code in step S712 is completed, the user presses the button 814 in FIG. 8B. If the recording apparatus 18 detects the pressing of the button 814, then in step S732, the recording apparatus 18 displays the screen for inputting a passcode in FIG. 8C. If the user wishes to suspend the processing, the user can also suspend the processing by pressing a button 812 in FIG. 8B.

FIG. 8C illustrates a form 820 for inputting a passcode and a numeric keypad 822 for inputting a passcode. In step S728, the user confirms the passcode displayed on the host terminal 14. In step S730, the user performs an operation of inputting the passcode to the recording apparatus 18 using the numeric keypad 822. In step S734, if the recording apparatus 18 receives the input of the passcode, the recording apparatus 18 collates the passcode generated in step S702 and the passcode input in step S730. If the passcodes match each other, the recording apparatus 18 initializes the value of the number of recorded images recorded by the recording apparatus 18 in the offline state.

That is, a process similar to that in the state where the online recording process is performed is performed, whereby the number of recorded images in the offline recording process becomes “0”, the error causing the restriction of the printing is removed, and the recording in the offline state can be continued. A message indicating that the recording can be continued may be displayed on the display unit 30.

In the determination of whether the number of recorded images reaches the limit of the number of recorded images within which the subscription service can be used in step S722, if it is determined that the number of recorded images has reached the limit, the CPU 20 of the recording apparatus 18 may display on the display unit 30 a notification screen indicating that the number of recorded images has reached the limit. Alternatively, the CPU 20 may notify the host terminal 14 that the use of the subscription service is to be stopped.

Alternatively, the QR code in step S708 may not include the passcode, and in step S724, the server 16 may transmit a fixed passcode defined in advance and stored in the recording apparatus 18. In this case, in steps S310 and S312, the server 16 transmits the passcode to the recording apparatus 18 in advance, and the recording apparatus 18 stores the passcode.

If a certain time elapses in the state where the screen in FIG. 8B is displayed on the display unit 30, or a passcode is input a predetermined number of times but does not match the passcode generated in step S702, the process for continuing the recording may be suspended, and a message indicating that the certain time has elapsed or the passcodes do not match each other may be displayed on the display unit 30. That is, if the certain time elapses in the state where the screen in FIG. 8B is displayed on the display unit 30, the recording apparatus 18 may be controlled not to receive the input of a passcode.

Even though the passcode is displayed in step S726, if the passcode is not input to the recording apparatus 18, inconsistency occurs between the recording information held in the server 16 and the recording information regarding the recording apparatus 18. Moreover, when the QR code is read in step S712, a case is also possible where incorrect recording information is obtained by erroneously recognizing the QR code in the reading because the display unit 30 is soiled or the camera performance of the host terminal 14 is low. Thus, the recording information in the server 16 obtained by the process for continuing the recording in the offline state may be stored as provisional recording information separately from recording information managed online. In this case, next time the recording apparatus 18 becomes online, formal recording information may be obtained by collating the provisional recording information and the recording information transmitted online. As a result of the collation, if there is inconsistency between the provisional recording information and the recording information transmitted online, information may be updated by giving priority to the recording information acquired online.

As described above, in the recording system 10, the number of recorded images in the recording process in the offline state is initialized by using the host terminal 14, and the recording process in the offline state can be continued. Thus, even when the recording apparatus 18 remains in the offline state, it is possible to appropriately manage recording performed by the recording apparatus 18.

### First Modification

In the above exemplary embodiment, a description has been given of a method for displaying various pieces of information to be transmitted to the server 16 as a QR code on the display unit 30 of the recording apparatus 18. The present disclosure, however, is not limited to this. Any method in which the host terminal 14 can acquire various pieces of information regarding the recording apparatus 18 to be transmitted to the server 16 may be used. That is, the recording unit 34 may record a QR code on a recording medium, and the host terminal 14 may read the recording medium on which the QR code is recorded. For example, in the case of a recording apparatus including a display device incompatible with the display of a QR code, the method for recording a QR code on a recording medium should be used. In a case where the recording apparatus 18 and the host terminal 14 can connect to each other through short-range wireless communication such as near-field communication (NFC) or Bluetooth® or a wired connection based on USB, required information may be transmitted and received using a method in which the recording apparatus 18 and the host terminal 14 can connect to each other.

### Second Modification

In the above exemplary embodiment, a description has been given of a method in which the user directly inputs to the recording apparatus 18 a passcode transmitted from the server 16. The present disclosure, however, is not limited to this. Any method in which information transmitted from the server 16 to the host terminal 14 can be input to the recording apparatus 18 may be used. That is, in the case where the recording apparatus 18 and the host terminal 14 can connect to each other through short-range wireless communication or a wired connection illustrated in the first modification, required information may be input using a method in which the recording apparatus 18 and the host terminal 14 can connect to each other. In a case where the recording apparatus 18 has a scanner function, the server 16 may encode a passcode into a QR code and output the QR code to the host terminal 14. In this case, the screen in FIG. 9B may be displayed on the display unit 60 of the host terminal 14 and read by the scanner function of the recording apparatus 18, thereby inputting the passcode to the recording apparatus 18.

### Third Modification

In the above exemplary embodiment, to manage recording in the offline state, the number of recorded images is used as predetermined information indicating the amount of recording performed using a consumable product. The present disclosure, however, is not limited to this. That is, as the predetermined information indicating the amount of recording and used to manage recording in the offline state, for example, the recording area may be used, or the discharge amount of ink may be used, or the offline time may be used. Alternatively, recording information (a log) may be used. As components that count the recording area, the discharge amount of ink, and the offline time, a variety of known techniques can be used. The number of recorded images, the recording area, and the discharge amount of ink may be used not only to manage recording in the offline state, but also to manage recording in the online state.

The present disclosure may also be applied to management in which, in a case where the remaining amount of ink falls below a predetermined value, the remaining amount of ink is transmitted to a server, and ink is automatically ordered. The recording apparatus 18 determines whether the remaining amount of ink has fallen below the predetermined value in the offline state. If it is determined that the remaining amount of ink has fallen below the predetermined value, the recording apparatus 18 displays a QR code including information regarding the remaining amount of ink with a warning. Then, the remaining amount of ink may be transmitted to the server 16 by a method similar to that in the exemplary embodiment via the host terminal 14 having read the QR code. Then, similarly to the exemplary embodiment, if the recording apparatus 18 receives the input of a passcode, the recording apparatus 18 lifts the warning.

Alternatively, a configuration may be employed in which four requirements, namely the number of recorded images, the recording area, the discharge amount of ink, and the offline time, can be selected as predetermined information for managing recording in the offline state. Then, based on a selected requirement, recording based on the subscription service may be managed. Further, recording in the offline state may be managed based on at least any two of the four requirements. In this case, the recording may be restricted at the time when all requirements in one of the plurality of requirements reach upper limit values set for the respective requirements. Alternatively, the recording may be restricted at the time when all requirements in the plurality of requirements reach upper limit values set for the respective requirements. As described above, a configuration is employed in which a plurality of requirements can be used as a requirement for managing recording, whereby it is possible to appropriately manage recording in the subscription service according to the type of the recording apparatus 18.

### Other Exemplary Embodiments

The present disclosure can also be achieved by the process of supplying a program for achieving one or more functions of the above exemplary embodiments to a system or an apparatus via a network or a storage medium, and of causing one or more processors of a computer of the system or the apparatus to read and execute the program. The present disclosure can also be achieved by a circuit (e.g., an ASIC or a field-programmable gate array (FPGA)) for achieving the one or more functions.

Based on a printing apparatus according to the present disclosure, it is possible to provide a mechanism for, in the state where the printing apparatus cannot communicate with a management server, transmitting the use state of the printing apparatus to the management server via another apparatus.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-137005, filed Aug. 25, 2023, which is hereby incorporated by reference herein in its entirety.

What is claimed is:

1. A printing apparatus which serves as a target of a service in which a user can use the printing apparatus at a flat rate, the printing apparatus comprising:
one or more processors; and
at least one memory having stored thereon instructions, which when executed by the one or more processors, cause the printing apparatus to:
restrict the printing performed by the printing apparatus in a state where the printing apparatus cannot communicate with a management server that manages the service and a use amount of a consumable product resulting from printing performed by the printing apparatus satisfies a predetermined condition; and
output a code for transmitting information regarding the printing apparatus to the management server via a user terminal.

2. The printing apparatus according to claim 1, wherein execution of the stored instructions further causes the printing apparatus to receive an input of a passcode and lift the restriction on printing in response to receiving the input of the passcode.

3. The printing apparatus according to claim 2, wherein the passcode to be input to the printing apparatus is received by the user terminal from the managed server after the information is transmitted to the management server according to the code.

4. The printing apparatus according to claim 1,
wherein the use amount includes a number of printed images printed by the printing apparatus in the state where the printing apparatus cannot communicate with the management server, and
wherein the predetermined condition is satisfied in a case where the number of printed images reaches a predetermined number of images.

5. The printing apparatus according to claim 1, wherein execution of the stored instructions further causes the printing apparatus to operate as a recording unit configured to record a log of printing,
wherein the use amount includes the log, and
wherein the predetermined condition is satisfied when a capacity of the log recorded in the state where the printing apparatus cannot communicate with the management server reaches a capacity recordable by the recording unit.

6. The printing apparatus according to claim 1,
wherein the use amount includes a remaining amount of the consumable product, and
wherein the predetermined condition is satisfied in a case where the remaining amount of the consumable product falls below a predetermined value in the state where the printing apparatus cannot communicate with the management server.

7. The printing apparatus according to claim 1, wherein the code is output by being displayed on a display unit of the printing apparatus.

8. The printing apparatus according to claim 1, wherein the code is output by the printing apparatus printing the code.

9. The printing apparatus according to claim 1, wherein the code is a Quick Response (QR) code including identification information regarding the printing apparatus, the use amount, an address of the management server, and a command to transmit the use amount to the address of the management server.

10. The printing apparatus according to claim 2, wherein execution of the stored instructions further causes the printing apparatus to restrict the input of the passcode after a predetermined time elapses since the code has+ been output.

11. A method for controlling a printing apparatus which serves as a target of a service in which a user can use the printing apparatus at a flat rate, the method comprising:
restricting the printing performed by the printing apparatus in a state where the printing apparatus cannot communicate with a management server that manages the service and a use amount of a consumable product resulting from printing performed by the printing apparatus satisfies a predetermined condition; and
outputting a code for transmitting information regarding the printing apparatus to the management server via a user terminal.

12. A non-transitory computer readable storage medium storing a computer program that executes a method for controlling a printing apparatus which serves as a target of a service in which a user can use the printing apparatus at a flat rate, the method comprising:
restricting the printing performed by the printing apparatus in a state where the printing apparatus cannot communicate with a management server that manages the service and a use amount of a consumable product resulting from printing performed by the printing apparatus satisfies a predetermined condition; and
outputting a code for transmitting information regarding the printing apparatus to the management server via a user terminal.
